(19) United States
(12) Patent Application Publication
(10) Pub. No.: US 2026/0119581 A1
(43) Pub. Date: Apr. 30, 2026

(54) DETECTING AMBIGUITIES IN PROMPTS TO LARGE LANGUAGE MODELS UTILIZING A SMALL LANGUAGE MODEL AND A RULE-BASED MODEL

(71) Applicant: Adobe Inc., San Jose, CA (US)

(72) Inventors: Md Mehrab Tanjim, Santa Clara, CA (US); Xiang Chen, Palo Alto, CA (US); Victor Soares Bursztyn, Mountain View, CA (US); Uttaran Bhattacharya, Sunnyvale, CA (US); Tung Mai, San Jose, CA (US); Vaishnavi Muppala, San Jose, CA (US); Akash Maharaj, San Jose, CA (US); Saayan Mitra, San Jose, CA (US); Eunyee Koh, Sunnyvale, CA (US); Yunyao Li, San Jose, CA (US); Kenneth Russell, Mountain View, CA (US)

(21) Appl. No.: 18/926,619

(22) Filed: Oct. 25, 2024

(51) Int. Cl. G06F 16/9032

(52) U.S. Cl. CPC G06F 16/90332

(57) ABSTRACT

Methods, systems, and non-transitory computer readable storage media are disclosed for detecting specific ambiguity types in queries to a large language model. The disclosed system determines a query in a prompt by a client device to a large language model. The disclosed system generates, utilizing a small language model, a label indicating that the query comprises an ambiguity of an identified ambiguity type of a plurality of ambiguity types according to a plurality of quantitative features of the query. Additionally, the disclosed system generates, for display to the client device, a response to the query based on the ambiguity of the identified ambiguity type.

### BACKGROUND

Recent years have seen significant improvements in hardware and software platforms for intelligent question-answering systems. Specifically, the capabilities of large language models (“LLMs”) have led to their integration into various artificial intelligence (“AI”) assisted computer software. In particular, LLMs excel in understanding natural language prompts for many different scenarios, including data analytics and digital content generation. Additionally, LLMs are effective for use in AI assistant models, responding to users and maintaining multi-turn conversations to assist a user in various tasks. Despite the advancements and the advantages of LLMs, existing LLM-based models exhibit a number of drawbacks or disadvantages, particularly regarding responding to ambiguous queries.

Although conventional systems answer queries through the use of LLMs, such systems have a number of problems or inadequacies in relation to accuracy, flexibility, and efficiency. To illustrate, conventional systems typically inaccurately or incompletely respond to ambiguous queries that do not contain sufficient relevant information and context for an LLM to generate an accurate response based solely on the query. To illustrate, when posed the question “What is it?”, conventional systems are often unable to generate an accurate LLM output, ignoring potential context given prior in a user interaction with the conventional system. Specifically, although some conventional systems attempt to detect ambiguities in prompts for task-oriented dialogue systems, these conventional systems are often unable to accurately respond to ambiguous prompts due to variances in different possible ambiguities.

Additionally, conventional systems are inflexible due to the use of rigid ambiguity detection processes. For instance, conventional systems are often limited to using a strict model to detect ambiguities, which often leads to incorrect labeling of unambiguous queries as ambiguous. To illustrate, some conventional systems use LLMs to analyze user queries using a one-size-fits-all approach that remains fixed regardless of the user query or context. Thus, when responding to queries that contain an ambiguity, many existing systems apply the same logic with the same LLMs, which results in inflexible and inaccurate responses to potentially ambiguous queries and even inaccurate responses to incorrectly mislabeled unambiguous queries.

Further, conventional systems are inefficient due to their use of large machine-learning models to perform ambiguity detection operations. For instance, some conventional systems use LLMs to analyze whether a query includes an ambiguity. Because LLMs demand significant computing resources (e.g., CPU/GPU processing capacity and computer memory) to train and deploy due to the large number of parameters and the number of calculations performed. Additionally, LLMs perform many calculations per generated response, leading to decreased speed of analysis and increased computing requirements during inference. Thus, many LLMs are often limited to use on computing devices with specific resources and preventing their use on some computing devices (e.g., mobile devices).

### SUMMARY

This disclosure describes one or more embodiments of systems, methods, and non-transitory computer readable media that solve one or more of the foregoing or other problems in the art by automatically detecting whether ambiguities and ambiguity types are present in prompts to large language models via machine-learning and/or rule-based models. For example, in response to determining a prompt in a query to a large language model, the disclosed systems utilize a small language model to generate a label indicating whether the query includes an ambiguity and to indicate certain ambiguity types of the detected ambiguity. In one or more embodiments, the disclosed systems also utilize a rule-based model to detect ambiguities of an additional ambiguity type in the query. In one or more embodiments, the disclosed systems generate a query response based on a detected ambiguity (e.g., of one or more ambiguity types), such as via automatic disambiguation according to the ambiguity type(s). In one or more additional embodiments, the disclosed systems generate synthesized ambiguous queries for training a small language model to accurately detect ambiguities of specific ambiguity types.

### BRIEF DESCRIPTION OF THE DRAWINGS

The disclosure describes one or more embodiments of the invention with additional specificity and detail by referencing the accompanying figures. The following paragraphs briefly describe those figures, in which:

FIG. 1 illustrates a diagram of an environment in which an ambiguity detection system operates in accordance with one or more embodiments.

FIG. 2 illustrates a diagram of an overview of the ambiguity detection system generating a query response based on a detected ambiguity using a small language model and a rule-based model in accordance with one or more embodiments.

FIG. 3 illustrates a diagram of a sample architecture of a small language model for detecting ambiguities in queries to large language models in accordance with one or more embodiments.

FIG. 4 illustrates a diagram of a sample architecture of a rule-based model for detecting ambiguities in queries to large language models in accordance with one or more embodiments.

FIG. 5 illustrates a diagram of the ambiguity detection system generating a set of synthetic ambiguity queries for training a small language model in accordance with one or more embodiments.

FIG. 6 illustrates a diagram of the ambiguity detection system training a small language model to detect ambiguities in queries in accordance with one or more embodiments.

FIGS. 7A-7C illustrate example graphical user interfaces for detecting and responding to ambiguous queries to large language models in accordance with one or more embodiments.

FIG. 8 illustrates an example schematic diagram of an ambiguity detection system in accordance with one or more embodiments.

FIG. 9 illustrates an example flowchart of a series of acts for detecting ambiguities and ambiguity types in queries to large language models utilizing a small language model in accordance with one or more embodiments.

FIG. 10 illustrates a block diagram of an example computing device in accordance with one or more embodiments.

### DETAILED DESCRIPTION

This disclosure describes one or more embodiments of an ambiguity detection system that generates responses to ambiguous queries by detecting ambiguities of certain ambiguity types using a small language model and a rule-based model. For example, the ambiguity detection system determines that a prompt to a large language model includes a query including one or more ambiguities. In one or more embodiments, the ambiguity detection system analyzes the user query to detect ambiguities of various ambiguity types using a small language model and/or a rule-based model. For example, the ambiguity detection system utilizes the small language model to detect whether the query contains an ambiguity and, if it does contain an ambiguity, attach a label designating the ambiguity as an ambiguity corresponding to a specific type of ambiguity. Further, in one or more embodiments, the ambiguity detection system utilizes the rule-based model to detect whether the query contains an ambiguity and, if it does contain an ambiguity, attach a label designating the ambiguity as an ambiguity corresponding to another specific type of ambiguity. The ambiguity detection system thus detects and labels specific ambiguity types in queries to large language models for additional downstream operations, such as automatic disambiguation.

In one or more embodiments, as mentioned, the ambiguity detection system determines whether a query in a prompt by a client device to a large language model includes ambiguities. Specifically, the ambiguity detection system utilizes a small language model to generate a label indicating whether the query includes at least one ambiguity of one or more ambiguity types (e.g., a pragmatic ambiguity type or a syntactic ambiguity type) based on quantitative features of the query. Additionally, in one or more embodiments, the ambiguity detection system utilizes a rule-based model to generate a label indicating whether the query includes an ambiguity of an additional ambiguity type (e.g., a lexical ambiguity type). In one or more embodiments, the ambiguity detection system also generates a response to the query based on the label indicating whether the query includes at least one ambiguity of one or more ambiguity types.

In one or more embodiments, the ambiguity detection system trains a small language model using synthetic ambiguous queries. For example, the ambiguity detection system trains the small language model using a training process that involves the small language model predicting ambiguity labels (and predicted ambiguity types) for synthetic ambiguous queries and comparing the predicted labels to ground-truth ambiguity labels for use in modifying parameters of the small language model. To facilitate such a training process, in one or more embodiments, the ambiguity detection system generates a library of synthetic ambiguous queries by modifying text content in a set of queries to include certain ambiguity types.

As suggested, the ambiguity detection system provides several advantages and benefits over conventional systems. For example, by using a small language model (and in some cases, a rule-based model) to determine specific ambiguity types of ambiguities in queries, the ambiguity detection system improves accuracy relative to conventional systems by facilitating automatic disambiguation and other query-related operations. In contrast to conventional systems that merely attempt to label queries as including ambiguities (e.g., via large language models), the ambiguity detection system detects the specific type of ambiguity of detected ambiguities. Specifically, by using a small language model to detect ambiguities of one or more certain ambiguity types and a rule-based model to detect ambiguities of one or more certain other ambiguity types, the ambiguity detection system is able to label and respond to ambiguities with higher precision. Additionally, by leveraging the small language model and rule-based model to detect specific ambiguity types, the ambiguity detection system eliminates or limits incorrect labeling of unambiguous queries as ambiguous. Further, by determining which ambiguity types are included in an ambiguous query, the ambiguity detection system responds accurately to ambiguous queries, such as via disambiguation of the queries according to the ambiguity types.

The ambiguity detection system also improves flexibility relative to conventional systems. Specifically, by using a small language model and a rule-based model to detect specific ambiguity types in queries, the ambiguity detection system uses a differentiated approach that incorporates additional user context in ambiguity detection and correction operations depending on the ambiguity type detected in the query. In contrast to conventional systems that use a one-size-fits-all approach, the ambiguity detection system flexibly analyzes queries according to the context by using multiple models to detect different types of ambiguities. More specifically, by using a small language model in combination with a rule-based model, the ambiguity detection system detects a number of different types of ambiguities while also adapting rules based on the specific context of the queries (e.g., for different knowledge domains and use cases).

The ambiguity detection system also improves efficiency relative to conventional systems by using a small language model and a rule-based model to detect ambiguities in queries. In contrast to conventional systems that utilize large language models to categorize ambiguities in queries, the ambiguity detection system utilizes a lightweight model (or combination of lightweight models) to detect ambiguities while also providing indications of ambiguity types in queries. By utilizing a smaller set of models to detect ambiguity types in queries, the ambiguity detection system reduces the computing resources (e.g., CPU/GPU processing and memory requirements) than conventional systems, thereby expanding the possible use cases to computing devices with lower resource capabilities (e.g., mobile devices). Further, by using a small language model and a rule-based model, the ambiguity detection system analyzes queries and detects ambiguities more quickly than conventional systems.

As illustrated by the foregoing discussion, the present disclosure utilizes a variety of terms to describe features and advantages of the ambiguity detection system. Additional detail is now provided regarding the meaning of such terms. For example, as used herein, the term “large language model” refers to an artificial intelligence model capable of processing and generating natural language text or other language-based prompts using language understanding. In particular, large language models are trained on large amounts of data to learn patterns and rules of language. As such, a large language model post-training is capable of generating output predictions that indicate visualization structures. Further, in some embodiments, a large language model includes or refers to one or more transformer-based neural networks capable of processing language-based prompts (e.g., natural language text) to generate outputs that range from predictive outputs, analyses, or combinations of data within stored content items. In particular, a large language model includes parameters trained (e.g., via deep learning) on large amounts of data to learn patterns and rules of language for summarizing and/or generating digital content. Additionally, as used herein, the term “small language model” refers to an artificial intelligence model capable of processing and generating natural language text or other language-based prompts using language understanding while having fewer neural network layers and parameters than existing large language models. For example, as described in more detail below, the ambiguity detection system utilizes a small language model that includes a sentence transformer neural network layer and a fully connected neural network layer.

As used herein, the term “rule-based model” refers to one or more computing operations that execute a set of rules on digital text to detect ambiguities in the text. For example, the ambiguity detection system utilizes a rule-based model to generate labels indicating whether queries include specific ambiguity types according to a predefined set of rules. To illustrate, a rule-based model includes executable code that executes a set of regular expressions on digital text to apply the rules for generating labels indicating whether the text includes a certain ambiguity type.

As used herein, the term “pragmatic ambiguity” refers to an ambiguity detected in a query where a meaning of the query is unclear depending on the context, reference, or scope of the query. For example, a pragmatic ambiguity indicates that a query is ambiguous (e.g., not clear) to what the query is referring according to the overall context or scope of the query. To illustrate, a query that states “How many do I have?” includes a pragmatic ambiguity, as it is not clear to what the query is referring for the total count.

As used herein, the term “syntactic ambiguity” refers to an ambiguity detected in a query where a meaning of the query is incomplete or allows for multiple interpretations. For example, a syntactic ambiguity includes ambiguities arising from an inherent fault in the sentence structure of the query. To illustrate, a query that states “Business event” includes a syntactic ambiguity, as it is not clear what the query is asking about the “business event.”

As used herein, the term “lexical ambiguity” refers to an ambiguity detected in a query where the meaning of a word or term in the query is not clear or has multiple interpretations. For example, a lexical ambiguity arises when it is not clear how to interpret a specific term in a query. To illustrate, a query that states “Are we removing abc123 from XYZ?” includes a lexical ambiguity, as it is not clear to what kinds of objects/entities abc123 and XYZ are referring.

As used herein, the term “masked query” refers to a query that includes one or more terms hidden or replaced after a masking operation. For example, the ambiguity detection system performs a masking operation to generate a masked query by selecting certain sentence entities (e.g., words, phrases, or character strings) and replacing them with a generic or predefined entity. To illustrate, in one or more embodiments, the ambiguity detection system generates a masked query by identifying an entity in a query (e.g., words and phrases set within quotation marks or containing digits) and replacing the query with a predefined entity (e.g., the word “ENTITY”).

As used herein, the term “data-related entity” includes a word or a symbol in a text query that one or more machine learning models or rule-based models process in connection with a specific topic or context. To illustrate, data-related entities refer to words, numbers, or other character strings that convey meaning within a sentence (e.g., segment, dataset) related to a specific knowledge domain. In one or more embodiments, a data-related entity includes a specific word or character string indicated in a predefined list of character strings corresponding to one or more specific topics.

As used herein, the term “web-connective features” includes textual features that cause a computing device to execute an operation via a connection to a network. To illustrate, a web-connective feature includes a URL or a hyperlink embedded in a query.

As used herein, the term “referential count” refers to a count of how often specific referential entities, words, or phrases are mentioned within a query. To illustrate, a referential count tracks the frequency of referential words that refer to other elements or objects in a query. To illustrate, a referential count includes a count for a set list of words (e.g., this, that, those, it, its, some, others, another, other, them, above, previous) in a query.

As used herein, the term “readability value” refers to a metric that indicates how readable and understandable a query is based on a structure of the query. For example, the ambiguity detection system generates a readability value via an algorithm that gauges the structure of a query based on factors such as sentence length, number of letters, number of words, word complexity, and syllable count in the query.

As used herein, the term “text embedding” refers to a representation of text in a vector space according to features of the text. For example, text embeddings represent words or phrases as numerical vectors for language processing. To illustrate, a text embedding captures semantic relationships between words in a query by positioning similar meanings close together in the vector space. In one or more embodiments, the ambiguity detection model utilizes a machine learning model to generate text embeddings for understanding context and relationships in text. Additionally, as used herein, the term “feature vector” refers to a numerical representation of data indicating textual characteristics based on quantitative features of a query. For example, a normalized numerical feature vector indicates characteristics such as word frequency or semantic meaning for a query.

As used herein, the term “synthetic ambiguous query” refers to an ambiguous query synthetically generated by the ambiguity detection system. To illustrate, synthetic ambiguous queries include sample queries generated or modified to include one or more ambiguity types to train a small language model. To illustrate, synthetic ambiguous queries include queries without proper nouns, queries without random referential pronouns, and queries with vague statements as generated by the ambiguity detection system.

As used herein, the term “loss function” refers to a function or set of functions that measures differences between content generated by a machine learning model relative to expected outcomes. To illustrate, a loss functions determines the difference between a machine learning model ambiguity label and a ground-truth ambiguity label. As used herein, the term “ground-truth label” refers to an actual label of whether a query contains an ambiguity. To illustrate, ground-truth labels include annotated data specifying whether a query contains an ambiguity. In one or more embodiments, a ground-truth label indicates an ambiguity type of an ambiguity.

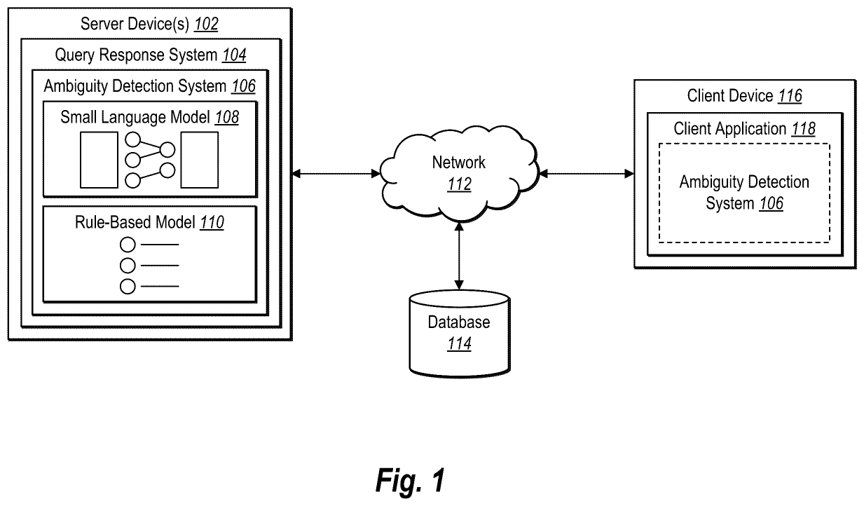

Additional detail regarding the ambiguity detection system will now be provided with reference to the figures. For example, FIG. 1 illustrates a schematic diagram of an example system environment for implementing an ambiguity detection system 106 in accordance with one or more embodiments. An overview of the ambiguity detection system 106 is described in relation to FIG. 1. Thereafter, a more detailed description of the components and processes of the ambiguity detection system 106 is provided in relation to the subsequent figures.

As shown, the system environment includes server device(s) 102, a database 114, a network 112, and a client device 116. Each of the components of the system environment communicate via the network 112, and the network 112 is any suitable network over which computing devices communicate. As mentioned, the system environment includes a client device 116. The client device 116 is one of a variety of computing devices, including a smartphone, a tablet, a smart television, a desktop computer, a laptop computer, a virtual reality device, an augmented reality device, or another computing device. The client device 116 communicates with the server device(s) 102 via the network 112. For example, the client device 116 provides information to server device(s) 102 indicating client device interactions (e.g., queries to a large language model) and receives information from the server device(s) 102 such as responses to queries. Thus, in some cases, the ambiguity detection system 106 on the server device(s) 102 provides and receives information based on client device interaction via the client device 116.

As shown in FIG. 1, the client device 116 includes a client application 118. In particular, the client application 118 is a web application, a native application installed on the client device 116 (e.g., a mobile application, a desktop application, etc.), or a cloud-based application where all or part of the functionality is performed by the server device(s) 102. Based on instructions from the client application 118, the client device 116 presents or displays information to a user, including queries to a large language model and query responses. In some cases, the client application 118 includes a version or a portion of the ambiguity detection system 106.

As illustrated in FIG. 1, the system environment includes the server device(s) 102. The server device(s) 102 generates, tracks, stores, processes, receives, and transmits electronic data, such as user queries to a large language model and query responses generated by the ambiguity detection system 106. The server device(s) 102, for example, receives data from the client device 116 in the form of an indication of a client device interaction (e.g., a query) to generate a query response from the client device interaction. In response, the server device(s) 102 transmits data to the client device 116 to display a query response based on the client device interaction.

In one or more embodiments, the server device(s) 102 communicates with the client device 116 to transmit and/or receive data via the network 112, including client device interactions, user queries, and/or other data. In one or more embodiments, the server device(s) 102 comprises a distributed server where the server device(s) 102 includes a number of server devices distributed across the network 112 and located in different physical locations. The server device(s) 102 comprises a content server, an application server, a communication server, a content editing server, a web-hosting server, a multidimensional server, and/or a machine learning server. The server device(s) 102 further accesses and utilizes the database 114 to store and retrieve information such as queries, synthetic ambiguous queries, all or part of the small language model 108, all or part of the rule-based model 110, and/or other data.

As further shown in FIG. 1, the server device(s) 102 also includes the ambiguity detection system 106 as part of a query response system 104. For example, in one or more embodiments, the query response system 104 is able to receive and respond to queries. For example, the query response system 104 provides tools for the client device 116, via the client application 118, to generate query responses using the ambiguity detection system 106.

In one or more embodiments, the server device(s) 102 includes all, or a portion of, the ambiguity detection system 106. For example, the ambiguity detection system 106 operates on the server device(s) 102 to determine ambiguities in queries to large language models and generate and provide query responses based on detected ambiguities. In some cases, the ambiguity detection system 106 utilizes, locally on the server device(s) 102 or from another network location (e.g., the database 114), a small language model 108 and/or a rule-based model 110 to detect ambiguities in queries and/or generate query responses. In addition, the ambiguity detection system 106 includes or communicates with the small language model 108 and/or the rule-based model 110 for implementation and training.

In certain cases, the client device 116 includes all or part of the ambiguity detection system 106. For example, the client device 116 generates, obtains (e.g., downloads), or utilizes one or more aspects of the ambiguity detection system 106 from the server device(s) 102. Indeed, in one or more implementations, as illustrated in FIG. 1, the ambiguity detection system 106 is located in whole or in part on the client device 116. For example, the ambiguity detection system 106 includes a web hosting application that allows the client device 116 to interact with the server device(s) 102. To illustrate, in one or more embodiments, the client device 116 accesses a web page supported and/or hosted by the server device(s) 102.

In one or more embodiments, the client device 116 and the server device(s) 102 work together to implement the ambiguity detection system 106. For example, in one or more embodiments, the server device(s) 102 trains one or more small language models (e.g., the small language model 108) discussed herein and provide the one or more small language models and one or more rule-based models (e.g., the rule-based model 110) to the client device 116 for implementation. In one or more embodiments, the server device(s) 102 trains one or more small language models, the client device 116 generates queries, and the server device(s) 102 generates query responses utilizing the one or more small language models and the one or more rule-based models. Furthermore, in one or more implementations, the client device 116 assists in training the one or more small language models.

Although FIG. 1 illustrates a particular arrangement of the system environment, in one or more embodiments, the system environment has a different arrangement of components and/or has a different number or set of components altogether. For instance, as mentioned, the ambiguity detection system 106 is implemented by (e.g., located entirely or in part on) the client device 116. In addition, in one or more embodiments, the client device 116 communicates directly with the ambiguity detection system 106, bypassing the network 112. Further, in one or more embodiments, the small language model 108 and the rule-based model 110 include one or more components stored in the database 114 or maintained by the server device(s) 102, the client device 116, or a third-party device.

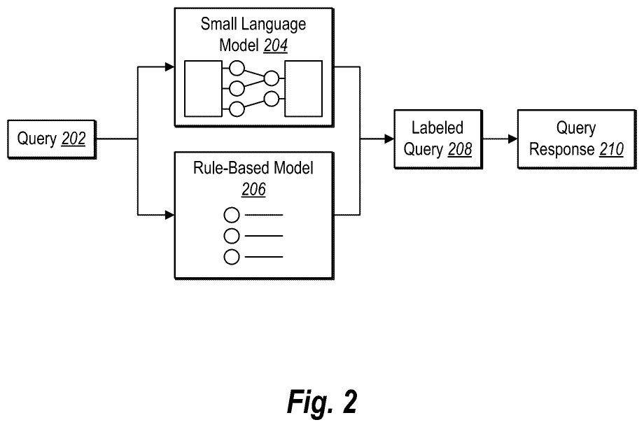

As mentioned, in one or more embodiments, the ambiguity detection system 106 detects an ambiguous query and generates a query response for the ambiguous query. FIG. 2 illustrates an overview of indicating whether a query is ambiguous and generating a query response for the query in accordance with one or more embodiments. Additional detail regarding the various acts and processes mentioned with respect to FIG. 2 is provided hereafter with respect to subsequent figures.

As illustrated in FIG. 2, the ambiguity detection system 106 receives a query 202 from a client device (e.g., the client device 116). In particular, the ambiguity detection system 106 receives the query 202 that includes a textual input with one or more questions or commands as part of one or more prompts to a large language model. Indeed, in some cases, the ambiguity detection system 106 receives the query 202 as part of a larger conversation with an AI assistant architecture involving a number of separate queries with a large language model and responses to the queries. Accordingly, in one or more embodiments, the ambiguity detection system 106 uses labels indicating ambiguous queries to generate responses to the queries and/or for performing other operations such as automatic disambiguation.

As further illustrated in FIG. 2, in one or more embodiments, the ambiguity detection system 106 processes the query 202 through a small language model 204. In particular, the ambiguity detection system 106 provides the query 202 to the small language model 204 to generate a label predicting whether the query 202 includes one or more ambiguities of one or more ambiguity types. In one or more embodiments, the small language model 204 utilizes or includes one or more neural network layers such as a sentence transformer neural network architecture and a fully connected neural network architecture that processes the query 202 to generate the label predicting whether there are one or more ambiguities of the one or more ambiguity types present in the query 202. In one or more embodiments, the small language model 204 uses additional features of the query 202 (e.g., query length, referential count, and/or readability value) to generate the label predicting whether there are one or more ambiguities of the one or more ambiguity types present in the query 202.

As further illustrated in FIG. 2, in one or more embodiments, the ambiguity detection system 106 processes the query 202 through a rule-based model 206. In particular, the ambiguity detection system 106 provides the query 202 to the rule-based model 206 to generate a label predicting whether there are one or more ambiguities of at least one ambiguity type present in the query 202. In one or more embodiments, the rule-based model 206 uses a set of at least one rule (e.g., whether at least one entity type is present after a masking process) to determine whether there is one or more ambiguity of the at least one ambiguity type present in the query 202.

As further illustrated in FIG. 2, the ambiguity detection system 106 generates a labeled query 208 using one or more of the small language model 204 and the rule-based model 206. In one or more embodiments, the ambiguity detection system 106 generates the labeled query 208 by labeling the query 202 with one or more labels indicating that one or more ambiguities of one or more ambiguity types are present in the query 202. Alternatively, in response to detecting that the query 202 does not include any ambiguities of the one or more ambiguity types, the ambiguity detection system 106 generates the label indicating that the query is unambiguous or not ambiguous.

As further illustrated in FIG. 2, the ambiguity detection system 106 generates a query response 210 using the labeled query 208. In one or more embodiments, the ambiguity detection system 106 generates a query response 210 corresponding to the one or more ambiguities of the one or more ambiguity types described in the labeled query 208, such as a response indicating that the query 202 includes the one or more ambiguities. In additional embodiments, the ambiguity detection system 106 generates the query response 210 in response to performing an automatic disambiguation on the labeled query 208. In certain embodiments, the query response 210 includes a response to the query 202 from the large language model by modifying the query 202 via automatic disambiguation and submitting the modified query to the large language model. In one or more embodiments, the query response 210 includes a request for further information to supplement the query 202 based on the one or more ambiguity types.

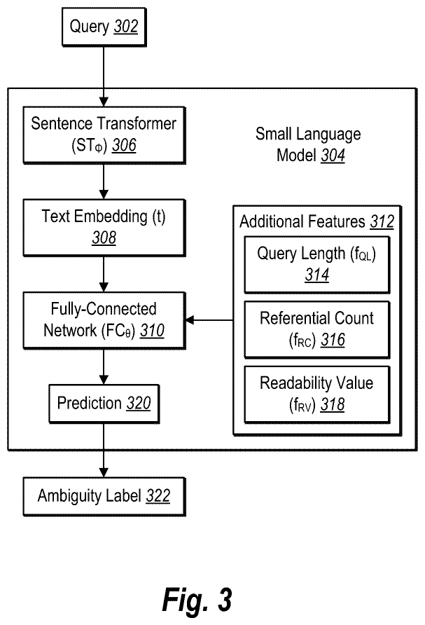

As mentioned above, in certain described embodiments, the ambiguity detection system 106 generates ambiguity labels using a small language model. In particular, the ambiguity detection system 106 passes a query through a small language model to generate a label indicating whether the query includes one or more ambiguities of one or more ambiguity types. FIG. 3 illustrates an example diagram of the ambiguity detection system 106 utilizing the small language model to generate an ambiguity label including a sample architecture for the small language model.

As illustrated in FIG. 3, the ambiguity detection system 106 receives a query 302 that includes a textual input containing a question, a command, or other instruction for a large language model. For example, the query 302 includes one or more natural language phrases or sentences requesting that the large language model provide a response to a question or to execute one or more computing operations based on a command or set of instructions. In one or more embodiments, the ambiguity detection system 106 receives the query 302 as one input in an ongoing conversation between the large language model and a client device (e.g., the client device 116).

As further illustrated in FIG. 3, in connection with determining whether the query 302 includes one or more ambiguities, the ambiguity detection system 106 feeds the query 302 into a small language model 304. In one or more embodiments, the ambiguity detection system 106 generates an ambiguity label 322 from the query 302 using the small language model 304 to indicate whether the query 302 includes one or more ambiguities, and if so, one or more ambiguity types of the one or more ambiguities. In one or more embodiments, the small language model 304 determines and provides one or more features (described hereinafter) of the query 302 to the small language model 304 to generate the ambiguity label 322 from the query 302.

As further illustrated in FIG. 3, in one or more embodiments, the small language model 304 processes the query 302 through a sentence transformer 306. For example, the small language model 304 utilizes the sentence transformer 306 to generate one or more embeddings for the query 302. In one or more embodiments, the sentence transformer 306 includes pretrained parameters and uses an encoder neural network (e.g., a bi-encoder neural network or a cross-encoder neural network) to generate the embeddings for the query 302.

To illustrate, the small language model 304 generates a text embedding 308 using the sentence transformer 306. In one or more embodiments, the small language model 304 generates the text embedding 308 based on the text of the query 302. In one or more embodiments, the small language model 304 generates the text embedding 308 as shown by the equation t=ST_{φ}(q), where t is the text embedding 308, ST is the sentence transformer 306, φ is the pretrained parameters of the sentence transformer 306, and q is the text of the query 302.

As further illustrated by FIG. 3, the small language model 304 processes the text embedding 308 through a fully-connected network 310. In one or more embodiments, the small language model uses the text embedding 308 to generate a prediction 320 as to whether one or more ambiguity of one or more ambiguity types present in the query 302. In one or more embodiments, the fully-connected network 310 includes neural network layers where each neuron is linked to each neuron in the preceding and following layers.

As further illustrated by FIG. 3, the small language model 304 processes a set of additional features 312 for input into the fully-connected network 310. In one or more embodiments, the small language model 304 generates the prediction 320 based on the text embedding 308 and the set of additional features 312. In particular, the ambiguity detection system 106 utilizes the fully-connected network 310 to process the text embedding 308 to detect certain ambiguity types based on the set of additional features 312 that represent certain patterns and statistical information associated with the query 302.

As further illustrated by FIG. 3, the small language model 304 determines a query length 314 as one feature of the set of additional features 312. In one or more embodiments, the small language model 304 determines the query length 314 by counting the total number of words in the query 302. For example, in various embodiments, shorter queries are often indicative of certain types of ambiguities (e.g., pragmatic ambiguity types or syntactic ambiguity types).

As further illustrated by FIG. 3, the small language model 304 generates a referential count 316 as one feature of the set of additional features 312. In one or more embodiments, the small language model 304 performs a count of preset referential words (e.g., this, that, those, it, its, some, others, another, other, them, above, previous) included in the query 302 to generate the referential count 316. For example, in various embodiments, queries including higher numbers of referential words are often indicative of certain types of ambiguities (e.g., pragmatic ambiguity types).

As further illustrated by FIG. 3, the small language model 304 generates a readability value 318 as one feature of the set of additional features 312. In one or more embodiments, the small language model 304 calculates the readability value 318 of the query 302 by analyzing the textual structure (e.g., number of letters, words, and sentences) of the query 302. For example, the ambiguity detection system 106 determines the readability value 318 as

$${f}_{R V} = \frac{a L}{W} - \frac{b S}{W} - c ,$$

where L represents the number of letters/characters in the query 302, S represents the number of words/character strings in the query 302, W represents the number of sentences or distinct phrases in the query 302, and a, b, and c are constants. To illustrate, an example of values for the constants includes a=5.89, b=30, and c=15.8, though in other examples the constants have different values. In one or more embodiments, queries with higher readability values more frequently indicate that the queries are unambiguous, while queries with lower readability values more frequently indicate that the queries are ambiguous.

As further illustrated by FIG. 3, the small language model 304 generates a prediction 320, using the fully-connected network 310 based on the text embedding 308 and the set of additional features 312. In one or more embodiments, the small language model generates the prediction 320 which predicts whether one or more ambiguities of one or more ambiguity types (e.g., the syntactic ambiguity type or the pragmatic ambiguity type) are present in the query 302. In one or more embodiments, the ambiguity detection system 106 generates the prediction 320 via the formula ŷ=FC_θ(t,f), where ŷ is the prediction 320, FC_{θ} is the fully-connected network 310 with θ parameters, t is the text embedding 308, and f is the set of additional features 312. Furthermore, in one or more embodiments, the set of additional features 312 is represented as f=[f_{QL}, f_{RC}, f_{RV}], where f_{QL} represents the query length 314, f_{RC} represents the referential count 316, and f_{RV} represents the readability value.

As further illustrated by FIG. 3, the ambiguity detection system 106 generates an ambiguity label 322 for the query 302 using the small language model 304. In one or more embodiments, the ambiguity detection system 106 generates the ambiguity label 322 to identify whether one or more ambiguities of one or more ambiguity types are present in the query 302. In one or more embodiments, the ambiguity detection system 106 generates the ambiguity label 322 to describe whether the query 302 contains at least one of a syntactic ambiguity or a pragmatic ambiguity.

Specifically, a pragmatic ambiguity type indicates that the query 302 is not ambiguous in its meaning based on contextual information, reference information, or scope of the query 302. An example of a query that includes an ambiguity of a pragmatic ambiguity type is “How many do I have?” or “What is it?” The ambiguity detection system 106 utilizes the small language model 304 to determine that the query has a pragmatic ambiguity type because it is unclear what the query is referring to for a total count (e.g., what is the item being counted).

Additionally, a syntactic ambiguity type indicates that the query 302 has an incomplete or incorrect sentence structure, allowing for a plurality of possible interpretations. For example, a query of “Business event” or “segment?” has an ambiguity of a syntactic ambiguity type. The ambiguity detection system 106 utilizes the small language model 304 to determine that the query has a syntactic ambiguity type because it is not clear what the query is asking about “business event” or “segment.”

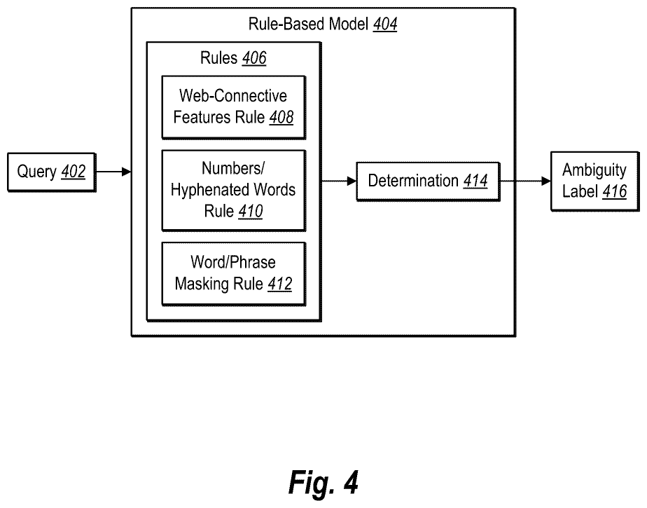

As mentioned above, in certain described embodiments, the ambiguity detection system 106 generates ambiguity labels using a rule-based model. In one or more embodiments, the ambiguity detection system 106 utilizes the rule-based model with a small language model for detecting a plurality of ambiguity types or alone for detecting a specific subset of ambiguity types. In particular, the ambiguity detection system 106 passes a query through a rule-based model to generate a label indicating whether there are one or more ambiguities of at least one ambiguity types present in the query. FIG. 4 illustrates an example diagram of a sample architecture of the rule-based model used by the ambiguity detection system 106 to generate an ambiguity label.

As illustrated in FIG. 4, the ambiguity detection system 106 receives a query 402 that includes a textual input containing a question, command, or set of instructions. For example, as previously mentioned, the query 402 includes one or more natural language phrases or sentences. In one or more embodiments, the ambiguity detection system 106 receives the query 402 as one input in an ongoing conversation between the ambiguity detection system 106 and a client device (e.g., the client device 116).

As further illustrated in FIG. 4, the ambiguity detection system 106 processes the query 402 using a rule-based model 404 (e.g., by providing the query 402 as a text input to the rule-based model 404). In one or more embodiments, the ambiguity detection system 106 uses the rule-based model 404 to generate an ambiguity label 416 based on the query 402. In one or more embodiments, the rule-based model 404 generates the ambiguity label 416 by applying one or more rules (described hereinafter).

As further illustrated in FIG. 4, the rule-based model 404 is an executable process (e.g., computing code) or a series of executable processes that contain one or more rules 406 to apply to the query 402 and determine whether the query 402 includes one or more ambiguities of a particular ambiguity type (e.g., a lexical ambiguity type). For example, the ambiguity detection system 106 executes the process(es) of the rule-based model 404 on the text string of the query 402 in response to receiving the query 402 before, after, in parallel with, or instead of processing the query 402 via a small language model. In one or more embodiments, the rule-based model 404 applies the one or more rules 406 to the query 402 to determine whether features of the query 402 satisfy the one or more rules 406. The rule-based model 404 generates a determination 414 based on whether features of the query 402 satisfy the one or more rules 406.

In one or more embodiments, the rule-based model 404 includes one or more rules to determine text or context attributes of the query 402. For example, as further illustrated in FIG. 4, the ambiguity detection system 106 uses the rule-based model 404 to evaluate the query 402 using a web-connective features rule 408. In one or more embodiments, the rule-based model 404 applies the web-connective features rule 408 to determine whether the query 402 includes any web-connective features such as embedded links or redirection instructions. Based on this determination, in certain embodiments, the rule-based model 404 removes any web-connective features identified by applying the web-connective features rule 408 to the query 402 (e.g., by deleting HTML or other code tags or instructions intended to execute computing code in response to an interaction with a portion of the query 402).

As further illustrated in FIG. 4, the ambiguity detection system 106 uses the rule-based model 404 to evaluate the query 402 using a numbers/hyphenated words rule 410. In one or more embodiments, the rule-based model 404 applies the numbers/hyphenated words rule 410 to determine whether the query 402 includes any ordinal numbers (e.g., 1st, 2nd) or hyphen-separated words (e.g., pre-requisite) that the numbers/hyphenated words rule 410 considers to be commonly used in a particular language. Based on this determination, in certain embodiments, the rule-based model 404 filters any ordinal numbers and hyphen-separated words identified by the numbers/hyphenated words rule 410 from the query 402.

As further illustrated in FIG. 4, the ambiguity detection system 106 uses the rule-based model 404 to evaluate the query 402 by using a word/phrase masking rule 412. In one or more embodiments, the rule-based model 404 applies the word/phrase masking rule 412 to determine whether the query 402 includes words and/or phrases matching certain criteria. To illustrate, the word/phrase masking rule 412 identifies words and/or phrases within a single or double quotation marks or with digits, periods, colons, underscores, or dashes. Based on this determination, in certain embodiments, the rule-based model 404 masks any words and/or phrases identified by the word/phrase masking rule 412 from the query 402. For example, the ambiguity detection system 106 uses the rule-based model 404 to mask the matched words with a predetermined word or character string (e.g., “ENTITY” or a string of special characters) for later use in connection with detecting ambiguities in the query 402. In one or more embodiments, the ambiguity detection system 106 uses the rule-based model 404 to mask matched portions of the query 402 after filtering or removing text via the web-connective features rule 408 and/or the numbers/hyphenated words rule 410.

As further illustrated in FIG. 4, the rule-based model 404 generates a determination 414 indicating whether the query 402 includes one or more ambiguities based on the application of the one or more rules 406. In one or more embodiments, the rule-based model 404 generates the determination 414 based on a prediction from a machine learning model (e.g., the prediction 320) that there is no ambiguity of one or more ambiguity types present in the query 402 and the application of the one or more rules 406. To illustrate, the ambiguity detection system 106 applies the rule-based model 404 after applying a small language model to the query 402 in response to determining that the small language model returned no ambiguities of a particular set of ambiguity types. Alternatively, the ambiguity detection system 106 applies the rule-based model 404 in parallel with the small language model. Additionally, although FIG. 4 illustrates a specific set of rules, in other embodiments, the ambiguity detection system 106 uses different rules (e.g., alphanumeric words) as customized for a particular implementation to detect lexical ambiguities in a particular industry setting or for specific entity data.

Further, in certain embodiments, the rule-based model 404 generates the determination 414 based on whether one or more entity types from a pre-defined list are absent from the query 402 after masking entities (e.g., by applying the word/phrase masking rule 412) in the query 402. For instance, the ambiguity detection system 106 accesses the pre-defined list and performs a comparison of the query 402 to a plurality of entity types in the pre-defined list. As an example, the pre-defined list of words includes a set of words (e.g., webpage, batch, profile, attribute, schema, dataset, source, destination, segment, audience, campaign, journey, offer) indicating specific lexical entity types as defined by an administrator or based on an analysis of digital documentation in connection with a specific topic or a purpose of the large language model.

To illustrate, the ambiguity detection system 106 uses the rule-based model 404 to generate the determination 414 in response to detecting the presence of the predefined word or character string (e.g., “ENTITY”) in the query 402. Accordingly, in response to detecting the presence of the predefined word or character string, the ambiguity detection system 106 determines whether an entity type from the pre-defined list is present in the query 402 to generate the determination 414. For example, for the query “What is the total size of 124abcde?” the ambiguity detection system 106 replaces “124abcde” with “ENTITY” and, in response to detecting the presence of “ENTITY”, determines that the query does not have an entity type (e.g., segment or ddataset) corresponding to the masked entity and is thus ambiguous.

As further illustrated in FIG. 4, the ambiguity detection system 106 generates an ambiguity label 416 based on the determination 414 generated by the rule-based model 404. In one or more embodiments, the ambiguity detection system generates the ambiguity label 416 to describe whether one or more ambiguities of at least one ambiguity type are present in the query 402. In certain embodiments, the ambiguity detection system 106 generates the ambiguity label 416 to indicate whether the query 402 contains a lexical ambiguity.

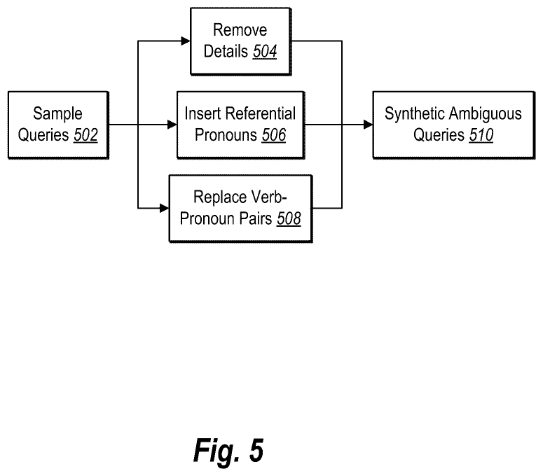

As mentioned above, in certain described embodiments, the ambiguity detection system 106 generates synthetic ambiguous queries to train a small language model. In particular, the ambiguity detection system 106 modifies a set of sample queries to generate synthetic ambiguous queries for training the small language model. FIG. 5 illustrates an example diagram of generating synthetic ambiguous queries in accordance with one or more embodiments.

As illustrated in FIG. 5, the ambiguity detection system 106 receives a set of sample queries 502. In one or more embodiments, the ambiguity detection system 106 collects the set of sample queries 502 from conversations with one or more large language models including one or more AI assistant architectures. To illustrate, the ambiguity detection system 106 collects the set of sample queries 502 from a set of previously generated queries (e.g., including user-generated queries or queries generated utilizing a text generation model). In certain embodiments, the ambiguity detection system 106 accesses the set of sample queries 502 from a storage system (e.g., the database 114).

As further illustrated in FIG. 5, the ambiguity detection system modifies the set of sample queries 502 by performing one or more of a set of query modification acts (e.g., the act of removing details 504, the act of inserting referential pronouns 506, and/or the act of replacing verb-pronoun pairs 508), described in more detail hereinafter. In one or more embodiments, the ambiguity detection system modifies the set of sample queries by performing a query modification act of removing details 504. In one or more embodiments, the ambiguity detection system 106 performs the query modification act of removing details 504 by removing words defined as being detailed. In certain embodiments, the ambiguity detection system 106 performs the query modification act of removing details 504 by matching the pattern “the { } of” and removing one or more words following the word “of” in the pattern. To illustrate, for the query “What is the name of my largest dataset,” the ambiguity detection system 106 removes all words after “of” resulting in “What is the name?” In additional embodiments, the ambiguity detection system 106 also omits proper nouns from queries.

As further illustrated in FIG. 5, in one or more embodiments the ambiguity detection system 106 modifies the set of sample queries 502 by the query modification act of inserting referential pronouns 506. In one or more embodiments, the ambiguity detection system 106 performs the query modification act of inserting referential pronouns 506 by inserting referential words from a set list (e.g., this, that, those, it, its, some, others, another, other, above, previous). Further, in certain embodiments, the ambiguity detection system 106 performs the query modification act of inserting referential pronouns 506 by locating occurrences of the word “the” in the set of sample queries 502 and replacing these occurrences of the word “the” with a random word from a set list of referential words. To illustrate, the ambiguity detection system 106 modifies “What is the name?” to generate “What is this name?” In some embodiments, the ambiguity detection system 106 repeats the above process a plurality of times on unambiguous queries with sentence length less than or equal to a predetermined number (e.g., 7) to generate a plurality of different ambiguous queries from a single query.

As further illustrated in FIG. 5, in one or more embodiments the ambiguity detection system 106 modifies the set of sample queries 502 by the query modification act of replacing verb-pronoun pairs 508. In one or more embodiments, the ambiguity detection system 106 performs the query modification act of replacing verb-pronoun pairs 508 by filtering all non-questions from the set of sample queries 502 and replacing verb-pronoun pairs in the remaining queries. Further, in certain embodiments, the ambiguity detection system 106 performs the query modification act of replacing verb-pronoun pairs 508 by using a parts-of-speech tagger to identify sentences starting with a verb and followed by a pronoun and replacing both the verb and the pronoun with a phrase randomly selected from a predetermined set of phrases (e.g., there is, there are, there is no such, there is no, there are no such, there are no, there is not any, it is, it is not, this is not, this is, that is, that is not). To illustrate, for a query “Tell me about ‘ABC’ dataset”, the ambiguity detection system 106 generates a query such as “There is no such ‘ABC’ dataset”. Furthermore, in one or more embodiments, the ambiguity detection system 106 repeats the above process a plurality of times on each sample query to generate a plurality of different ambiguous queries for each sample query.

As further illustrated in FIG. 5, the ambiguity detection system 106 generates a set of synthetic ambiguous queries 510 from the set of sample queries 502 by performing one or more of the set of query modification acts (e.g., the act of removing details 504, the act of inserting referential pronouns 506, the act of replacing verb-pronoun pairs 508). In one or more embodiments, the set of synthetic ambiguous queries 510 includes modified versions of the set of sample queries 502. In one or more embodiments, the ambiguity detection system 106 applies the set of synthetic ambiguous queries 510 to train a small language model.

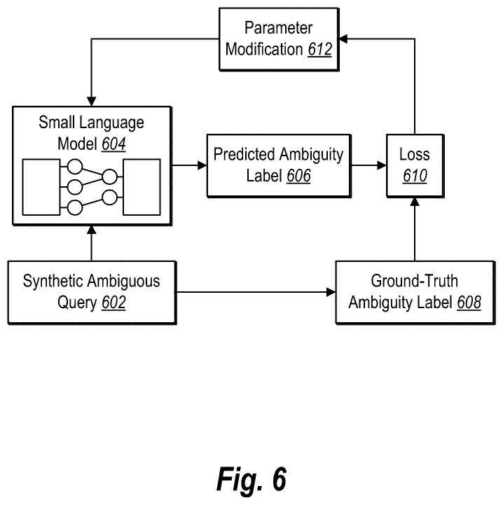

As mentioned above, in certain embodiments, the ambiguity detection system 106 trains a small language model to generate ambiguity labels. In particular, the ambiguity detection system 106 uses a set of synthetic ambiguous queries to generate predicted ambiguity labels to compare with the actual ambiguities present in the synthetic ambiguous queries. FIG. 6 illustrates an example diagram for training a small language model in accordance with one or more embodiments.

As illustrated in FIG. 6, the ambiguity detection system 106 utilizes a synthetic ambiguous query 602 for training a small language model 604. In one or more embodiments, the ambiguity detection system 106 generates the synthetic ambiguous query 602 to train the small language model 604 to generate ambiguity labels based on a set of ambiguity types (e.g., pragmatic ambiguity types and/or syntactic ambiguity types, as described previously). Further information on generating the synthetic ambiguous query 602 was illustrated in FIG. 5.

As further illustrated in FIG. 6, the ambiguity detection system 106 provides the synthetic ambiguous query 602 to the small language model 604 to train the small language model 604. In one or more embodiments, the ambiguity detection system 106 utilizes the small language model 604 to generate a predicted ambiguity label 606 for the synthetic ambiguous query 602. In certain embodiments, the ambiguity detection system 106 uses the small language model 604 to generate the predicted ambiguity label 606 indicating whether one or more ambiguity of one or more ambiguity types (e.g., pragmatic or syntactic ambiguity types) is present in the synthetic ambiguous query 602, generating the predicted ambiguity label 606.

As further illustrated in FIG. 6, the ambiguity detection system 106 generates a ground-truth ambiguity label 608 to serve as a reference for training the small language model 604. In one or more embodiments, the ambiguity detection system 106 generates the ground-truth ambiguity label 608 as the actual ambiguity label applied to the synthetic ambiguous query 602. For example, the ground-truth ambiguity label 608 includes a label generated for the synthetic ambiguous query 602 by a user.

As further illustrated in FIG. 6, the ambiguity detection system 106 determines a loss 610 by comparing the predicted ambiguity label 606 and the ground-truth ambiguity label 608. In one or more embodiments, the ambiguity detection system 106 determines the loss 610 to indicate the difference between the predicted ambiguity label 606 and the ground-truth ambiguity label 608. In certain embodiments, the loss 610 includes a loss function (e.g., a cross-entropy loss function) to calculate the difference between the predicted ambiguity label 606 and the ground-truth ambiguity label 608.

As further illustrated in FIG. 6, the ambiguity detection system 106 uses the loss 610 to perform a parameter modification 612 to modify parameters of the small language model 604. In one or more embodiments, the ambiguity detection system 106 uses the calculated loss from the loss function in the loss 610 to inform the parameter modification 612. In certain embodiments, the ambiguity detection system 106 employs the parameter modification 612 to adjust the parameters of the small language model 604 to reduce the difference between the predicted ambiguity label 606 and the ground-truth ambiguity label 608. Further, in one or more embodiments, the ambiguity detection system 106 uses a weighted sampling during training of the small language model 604 to perform the parameter modification 612.

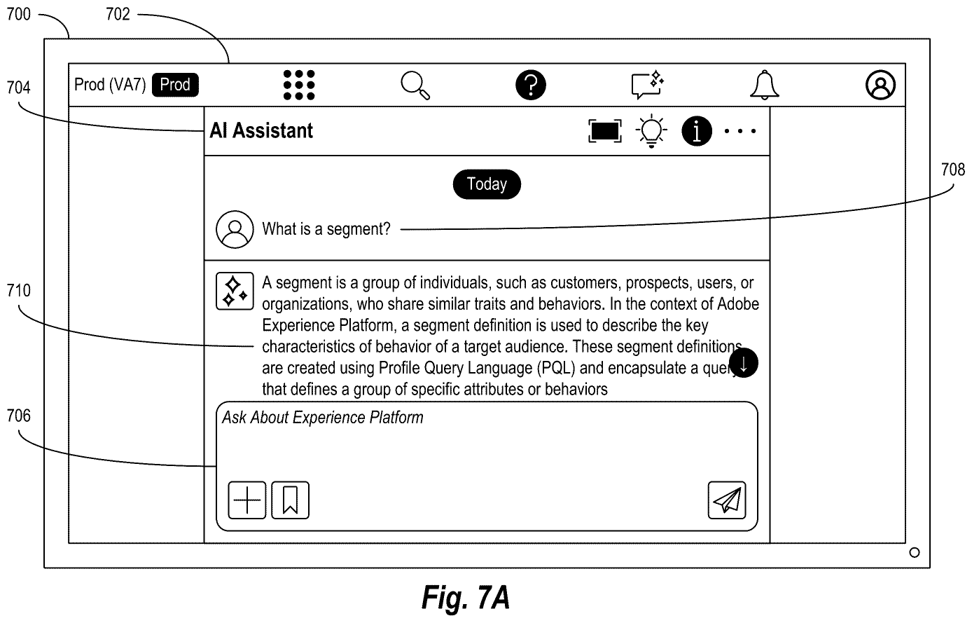

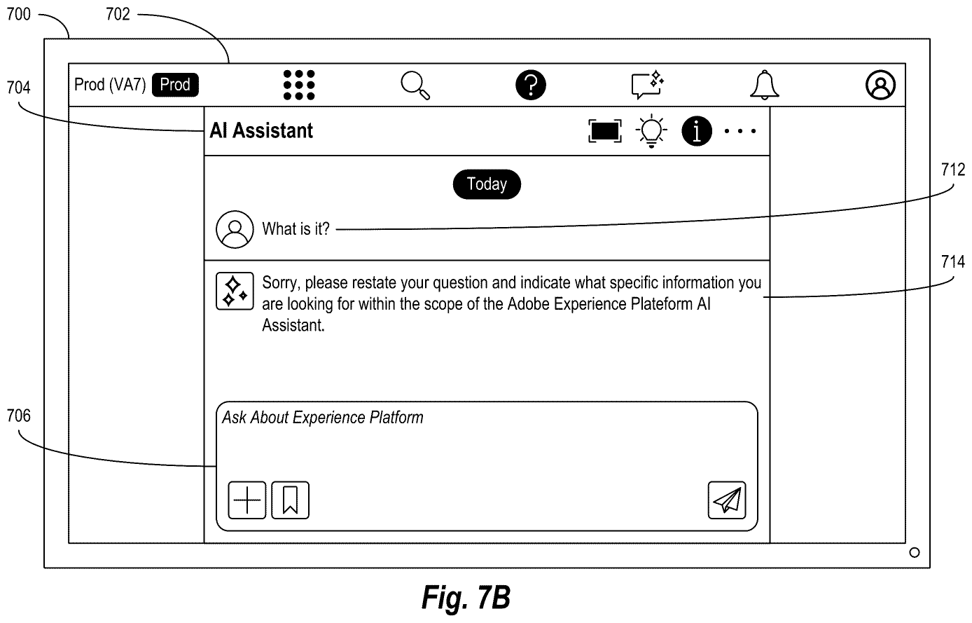

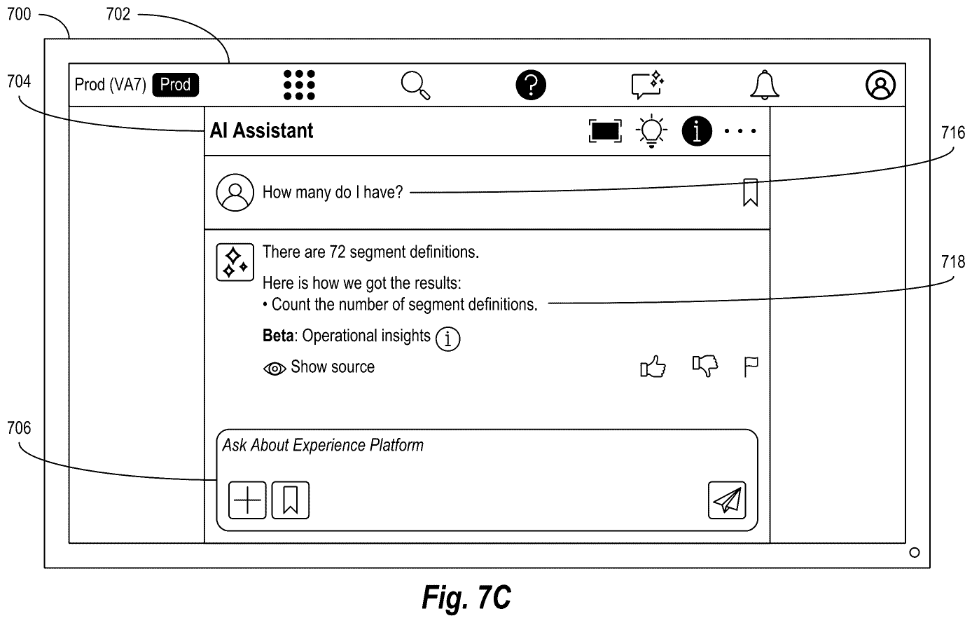

As noted above, in certain embodiments, the ambiguity detection system 106 generates query responses to queries that potentially contain one or more ambiguities of one or more ambiguity types. In particular, the ambiguity detection system 106 generates query responses based on whether the queries presented contain one or more ambiguities of the one or more ambiguity types. FIGS. 7A-7C illustrate example query responses in an example client device interface to queries potentially containing one or more ambiguities of one or more ambiguity types. In particular, FIG. 7A illustrates an example response to an unambiguous query in an example client device interface. FIG. 7B illustrates a potential example response to an ambiguous query in an example client device interface. FIG. 7C illustrates another potential example response to an ambiguous query in an example client device interface.

As illustrated in FIG. 7A, in one or more embodiments, a client device 700. a client device interface 702 for interacting with a large language model. In one or more embodiments, the ambiguity detection system 106 communicates with the client device 700 via the client device interface 702 to receive one or more inputs (e.g., a query) intended for the large language model and to display one or more outputs to the client device (e.g., a query response).

As further illustrated in FIG. 7A, in one or more embodiments, the ambiguity detection system 106 presents an AI assistant 704 for display in the client device interface 702. In one or more embodiments, the AI assistant 704 includes a software system designed to understand and process natural language inputs and output responses based on the inputs. Further, in certain embodiments, the AI assistant 704 uses the large language model to generate interactions with client devices, such as for carrying out a conversation between the large language model and a user of the client device 700.

As further illustrated in FIG. 7A, in one or more embodiments, the client device 700 presents an AI assistant 704 that includes a text input interface 706. In one or more embodiments, the client device 700 receives client device interactions (e.g., queries) via the text input interface 706.

As further illustrated in FIG. 7A, in one or more embodiments, the ambiguity detection system 106 receives an unambiguous query 708 (e.g., “What is a segment?”) provided via the text input interface 706. Based on the unambiguous query 708, the ambiguity detection system 106 generates a direct query response 710 to answer the unambiguous query 708 (e.g., a response defining a segment) for display to the client device interface 702.

As illustrated in FIG. 7B, in one or more embodiments, the ambiguity detection system 106 receives an ambiguous query 712 (e.g., “What is it?”) provided via the text input interface 706 of the client device 700. In one or more embodiments, the ambiguity detection system 106 processes the ambiguous query 712 to detect one or more ambiguities in the ambiguous query 712. Based on the ambiguous query 712 and the detected ambiguity (or ambiguities), the ambiguity detection system 106 generates a clarifying query response 714 (e.g., a request to restate the question with an indication of specific information sought) soliciting clarifying information to prompt an additional client device interaction via the text input interface 706. Further, in one or more embodiments, the ambiguity detection system 106 provides the clarifying query response 714 for display via the client device interface 702. In one or more embodiments, the ambiguity detection system 106 generates the clarifying query response 714 based on an ambiguity type of an ambiguity detected in the ambiguous query 712 (e.g., by determining the specific information sought based on the ambiguity type).

In one or more embodiments, the ambiguity detection system 106 utilizes one or more detected ambiguity types to automatically disambiguate an ambiguous query. For example, as illustrated in FIG. 7C, in one or more embodiments, the ambiguity detection system 106 receives an ambiguous query 716 (e.g., “How many do I have?”) from the text input interface 706. Based on the ambiguous query 716, the ambiguity detection system 106 performs an automatic disambiguation to generate an ambiguity sensitive query response 718 (e.g., a response based on the understanding of the context of the ambiguous query 716 by the AI assistant 704) answering the ambiguous query 716 and explaining the reasoning of the AI assistant 704.

To illustrate, the ambiguity detection system 106 uses an ambiguity type of a detected ambiguity to determine what information is missing from the ambiguous query 716. Additionally, in one or more embodiments, the ambiguity detection system 106 analyzes previous queries and/or responses in the interactions with the AI assistant 704 to identify/predict likely correspondences to the missing information (e.g., based on contextual information) and generate a new query including the missing information. Accordingly, the ambiguity detection system 106 uses the identified information to generate the ambiguity sensitive query response 718 with information relevant to the new query (e.g., by providing the new query to the large language model). Further, in one or more embodiments, the ambiguity detection system 106 provides the ambiguity sensitive query response 718 to the client device interface 702.

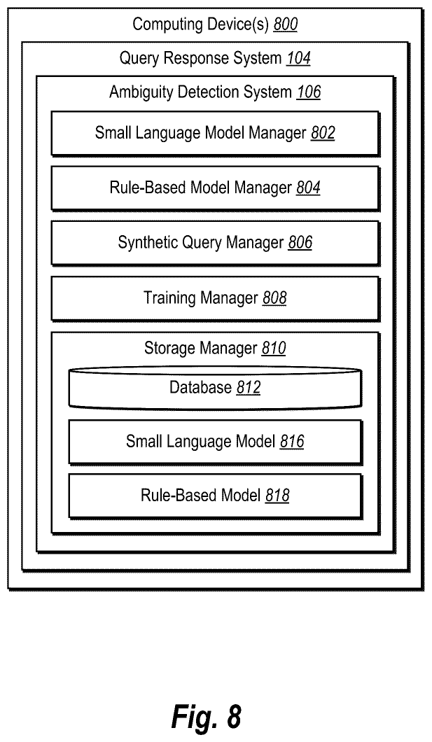

Referring now to FIG. 8, additional detail will be provided regarding components and capabilities of the ambiguity detection system 106. Specifically, FIG. 8 illustrates an example schematic diagram of the ambiguity detection system 106 on an example computing device(s) 800 (e.g., one or more of the client device 116 and the server device(s) 102). As shown in FIG. 8, the ambiguity detection system 106 includes a small language model manager 802, a rule-based model manager 804, a synthetic query manager 806, a training manager 808, and a storage manager 810.

As mentioned, the ambiguity detection system 106 includes a small language model manager 802. In particular, the small language model manager 802 operates, modifies, adjusts, or augments the parameters of a small language model (e.g., the small language model 816) in generating a label indicating whether a query includes one or more ambiguities of one or more ambiguity types (e.g., by communicating with the training manager 808). Additionally, the small language model manager 802 generates labels for queries related to one or more ambiguity types, such as by receiving a query from a client device and generating a label indicating whether the query includes one or more ambiguities of the one or more ambiguity types (e.g., a syntactic or a pragmatic ambiguity).

As mentioned, the ambiguity detection system 106 includes a rule-based model manager 804. In particular, the rule-based model manager 804 operates, modifies, adjusts, or augments the rules employed in a rule-based model (e.g., the rule-based model 818) in generating a label indicating whether a query includes one or more ambiguities of at least one ambiguity type. Additionally, the rule-based model manager 804 generates labels for queries related to, such as by receiving a query from a client device and generating a label indicating whether the query includes one or more ambiguities of at least one ambiguity type (e.g., a lexical ambiguity).

As mentioned, the ambiguity detection system 106 includes a synthetic query manager 806. In particular, the synthetic query manager 806 generates, modifies, or adjusts synthetic queries for training purposes. For example, the synthetic query manager 806 receives a sample set of queries and performs a series of query modification acts to generate a set of synthetic queries.

As mentioned, the ambiguity detection system 106 includes a training manager 808. In particular, the training manager 808 trains a small language model (e.g., the small language model 816) to generate labels indicating whether one or more ambiguities of one or more ambiguity types are present in a query (e.g., by communicating with the small language model manager 802). For example, the training manager 808 trains the small language model by comparing predicted ambiguity labels with ground-truth ambiguity labels via a loss function and modifying parameters of the small language model accordingly.

The ambiguity detection system 106 further includes a storage manager 810. The storage manager 810 operates in conjunction with the other components of the ambiguity detection system 106 and includes one or more memory devices such as the database 812 (e.g., the database 114) that stores various data such as synthetic queries, client device contextual information, and other information. In some cases, the storage manager 810 also manages or maintains a small language model 816 and a rule-based model 818 for detecting ambiguities using one or more components of the ambiguity detection system 106 as described above.

In one or more embodiments, each of the components of the ambiguity detection system 106 are in communication with one another using any suitable communication technologies. Additionally, the components of the ambiguity detection system 106 are in communication with one or more other devices including one or more client devices described above. It will be recognized that although the components of the ambiguity detection system 106 are shown to be separate in FIG. 8, any of the subcomponents are optionally combined into fewer components, such as into a single component, or divided into more components as serves a particular implementation. Furthermore, although the components of FIG. 8 are described in connection with the ambiguity detection system 106, at least some of the components for performing operations in conjunction with the ambiguity detection system 106 described herein are optionally implemented on other devices within the environment.

The components of the ambiguity detection system 106 include software, hardware, or both. For example, the components of the ambiguity detection system 106 include one or more instructions stored on a computer-readable storage medium and executable by processors of one or more computing devices (e.g., the computing device(s) 800). When executed by the one or more processors, the computer-executable instructions of the ambiguity detection system 106 cause the computing device(s) 800 to perform the methods described herein. Alternatively, the components of the ambiguity detection system 106 comprise hardware, such as a special purpose processing device to perform a certain function or group of functions. Additionally, or alternatively, the components of the ambiguity detection system 106 include a combination of computer-executable instructions and hardware.

Furthermore, the components of the ambiguity detection system 106 performing the functions described herein, for example, are implemented as part of a stand-alone application, as a module of an application, as a plug-in for applications including content management applications, as a library function or functions that are called by other applications, and/or as a cloud-computing model. Thus, in various embodiments, the components of the ambiguity detection system 106 are implemented as part of a stand-alone application on a personal computing device or a mobile device. Alternatively, or additionally, the components of the ambiguity detection system 106 are implemented in any application that allows creation and delivery of content to users, including, but not limited to, applications in ADOBE® EXPERIENCE MANAGER or ADOBE® EXPERIENCE CLOUD®.

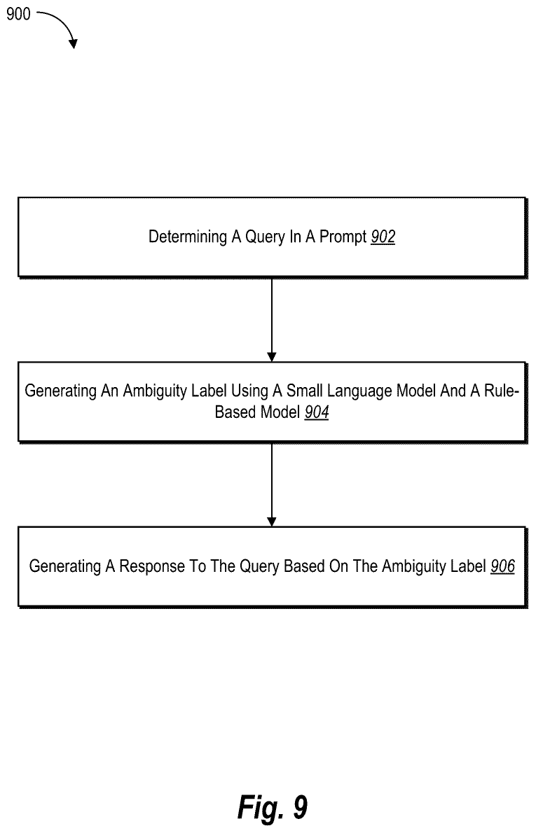

FIGS. 1-8, the corresponding text, and the examples provide a number of different systems, methods, and non-transitory computer readable media for detecting whether one or more ambiguities of one or more ambiguity types are present in a query and generating query responses in accordance with whether the one or more ambiguities of the one or more ambiguity types are present in the query. In addition to the foregoing, embodiments can also be described in terms of flowcharts comprising acts for accomplishing a particular result. For example, FIG. 9 illustrates a flowchart of example sequences or series of acts in accordance with one or more embodiments.

While FIG. 9 illustrates acts according to particular embodiments, alternative embodiments omit, add to, reorder, and/or modify any of the acts shown in FIG. 9. The acts of FIG. 9 can be performed as part of a method. Alternatively, a non-transitory computer readable medium can comprise instructions, that when executed by one or more processors, cause a computing device to perform the acts of FIG. 9. In still further embodiments, a system can perform the acts of FIG. 9. Additionally, in various embodiments, the acts described herein are repeated or performed in parallel with one another or in parallel with different instances of the same or other similar acts.

FIG. 9 illustrates an example series of acts 900 for generating a response to a query based on a generated ambiguity label. In particular, the series of acts 900 includes an act 902 of determining whether a query exists in a prompt. For example, the act 902 involves receiving a prompt from a client device and determining whether it comprises a query. Further, the series of acts 900 includes an act 904 of generating an ambiguity label using a small language model and a rule-based model. For example, the act 904 includes processing the query through the small language model and the rule-based model to generate an ambiguity label indicating whether the query includes one or more ambiguities of one or more ambiguity types. Further, the series of acts 900 includes an act 906 of generating a response to the query based on the ambiguity label. For example, the act 906 includes analyzing the ambiguity labels attached to the query to generate a response based on an automatic disambiguation performed by matching whether one or more ambiguities of one or more ambiguity types are present in the query.

In one or more embodiments, the series of acts 900 includes determining a query in a prompt by a client device to a large language model; generating, utilizing a small language model, a label indicating that the query comprises an ambiguity of an identified ambiguity type of a plurality of ambiguity types according to a plurality of quantitative features of the query; and generating, for display to the client device, a response to the query based on the ambiguity of the identified ambiguity type.

In one or more embodiments, the series of acts 900 includes determining, utilizing the small language model, that the ambiguity is a pragmatic ambiguity type or a syntactic ambiguity type from contents of the query or determining whether the query comprises an additional ambiguity of the lexical ambiguity type by applying the plurality of rules of the rule-based model to the query.

In one or more embodiments, the series of acts 900 includes masking, utilizing one or more regular expression operations, one or more data-related entities in the query; by removing web-connective features, filtering one or more ordinal numbers or one or more hyphen-separated words from a set of hyphen-separated words, or masking one or more words or phrases in the query that match a pre-defined list of words or phrases by replacing the one or more words or phrases with a pre-determined character string; and generating an additional label indicating that the query comprises the additional ambiguity of the lexical ambiguity type in response to determining that one or more entity types are missing from the query in response to masking the query.

In one or more embodiments, the series of acts 900 includes determining a query length of the query; determining a referential count indicating a correlation of a set of words in the query to a predetermined set of words; and generating a readability value for the query based on a number of letters, words, and sentences in the query.

In one or more embodiments, the series of acts 900 includes generating a text embedding of the query and a normalized numerical feature vector for the plurality of quantitative features of the query; and generating, based on the text embedding and the normalized numerical feature vector, one or more predictions that the query comprises one or more ambiguities of the plurality of ambiguity types.

In one or more embodiments, the series of acts 900 includes removing, from a first set of sample queries, one or more details matching a first predefined pattern of words; inserting a plurality of referential pronouns into a second set of sample queries; and replacing, in a third set of sample queries comprising non-question queries, verb-pronoun pairs with one or more phrases from a pre-defined list of phrases marked as ambiguous.

In one or more embodiments, the series of acts 900 incudes generating, utilizing the small language model, predicted labels for the plurality of synthetic ambiguous queries; and adjusting, utilizing the plurality of synthetic ambiguous queries, parameters of the small language model to reduce differences between the predicted labels and ground-truth labels of the plurality of synthetic ambiguous queries.

In one or more embodiments, the series of acts 900 includes generating, utilizing a sentence transformer neural network of the small language model, a text embedding representing the query; generating, from the query, a feature vector for a plurality of quantitative features of the query; and generating, utilizing a fully connected neural network of the small language model, the label from the text embedding and the feature vector.

In one or more embodiments, the series of acts 900 includes determining a query length of the query; determining a referential count indicating a correlation of a set of words in the query to a predetermined set of words; generating a readability value for the query based on a number of letters, words and sentences in the query; and generating the feature vector comprising the query length, the referential count, and the readability value.

In one or more embodiments, the series of acts 900 includes generating a masked query by masking, utilizing a plurality of regular expression operations, a data-related entity in the query; and generating, utilizing the rule-based model, the label indicating that the ambiguity is of a lexical ambiguity type in response to determining that an entity type of a set of pre-defined entity types is missing from the masked query.

In one or more embodiments, the series of acts 900 includes generate the label determining, utilizing the small language model, that the identified ambiguity type of the plurality of ambiguity types is a pragmatic ambiguity type or a syntactic ambiguity type by determining, utilizing the small language model, that the query does not include ambiguities of the pragmatic ambiguity type or the syntactic ambiguity type; and determining, utilizing the rule-based model in response to determining that the query does not include ambiguities of the pragmatic ambiguity type or the syntactic ambiguity type, that the ambiguity is of a lexical ambiguity type.

In one or more embodiments, the series of acts 900 includes removing, from a set of sample queries, one or more details matching a first predefined pattern of words; inserting a plurality of referential pronouns into the set of sample queries; and replacing, in non-question queries of the set of sample queries and utilizing a parts-of-speech tagger, verb-pronoun pairs with one or more phrases from a pre-defined list of phrases marked as ambiguous.

In one or more embodiments, the series of acts 900 includes determining a query in a prompt by a client device to a large language model; performing a step for generating a label indicating that the query comprises an ambiguity of an identified ambiguity type of a plurality of ambiguity types; and generating, for display to the client device, a response to the query based on the ambiguity of the identified ambiguity type.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

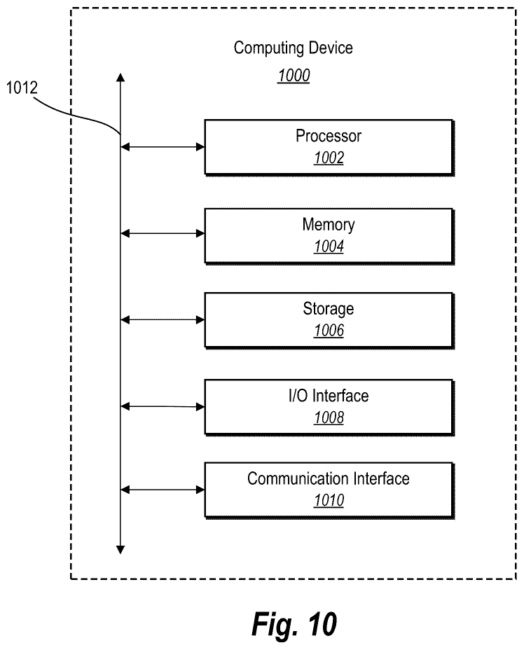

FIG. 10 illustrates, in block diagram form, an example computing device 1000 (e.g., the computing device 1000, the client device(s) 110, and/or the server device(s) 102) that may be configured to perform one or more of the processes described above. As shown by FIG. 10, the computing device can comprise a processor(s) 1002, memory 1004, a storage device 1006, an I/O interface 1008, and a communication interface 1010.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1006 and decode and execute them. The computing device 1000 includes memory 1004, which is coupled to the processor(s) 1002. The memory 1004 may be used for storing data, metadata, and programs for execution by the processor(s). The memory 1004 may include one or more of volatile and non-volatile memories. The memory 1004 may be internal or distributed memory. The computing device 1000 includes a storage device 1006 includes storage for storing data or instructions. As an example, and not by way of limitation, storage device 1006 can comprise a non-transitory storage medium described above. The computing device 1000 also includes one or more input or output (“I/O”) devices/interfaces 1008, which are provided to allow a user to provide input to (such as user strokes), receive output from, and otherwise transfer data to and from the computing device 1000. These I/O devices/interfaces 1008 may include a mouse, keypad or a keyboard, a touch screen, camera, optical scanner, network interface, modem, other known I/O devices or a combination of such I/O devices/interfaces 1008.

The computing device 1000 can further include a communication interface 1010. The communication interface 1010 can include hardware, software, or both. The communication interface 1010 can provide one or more interfaces for communication (such as, for example, packet-based communication) between the computing device and one or more other computing devices (e.g., computing device 1000) or one or more networks. The computing device 1000 can further include a bus 1012. The bus 1012 can comprise hardware, software, or both that couples components of computing device 1000 to each other.

What is claimed is:

1. A non-transitory computer readable medium comprising instructions that, when executed by at least one processor, cause a computing device to perform operations comprising:
determining a query in a prompt by a client device to a large language model;
generating, utilizing a small language model, a label indicating that the query comprises an ambiguity of an identified ambiguity type of a plurality of ambiguity types according to a plurality of quantitative features of the query; and
generating, for display to the client device, a response to the query based on the ambiguity of the identified ambiguity type.

2. The non-transitory computer readable medium of claim 1, wherein generating the label comprises determining, utilizing the small language model, that the ambiguity is a pragmatic ambiguity type or a syntactic ambiguity type from contents of the query.

3. The non-transitory computer readable medium of claim 2, wherein the operations further comprise:
determining a rule-based model comprising a plurality of rules corresponding to a lexical ambiguity type; and
determining whether the query comprises an additional ambiguity of the lexical ambiguity type by applying the plurality of rules of the rule-based model to the query.

4. The non-transitory computer readable medium of claim 3, wherein applying the plurality of rules comprises:
masking, utilizing one or more regular expression operations, one or more data-related entities in the query; and
generating an additional label indicating that the query comprises the additional ambiguity of the lexical ambiguity type in response to determining that one or more entity types are missing from the query in response to masking the query.

5. The non-transitory computer readable medium of claim 4, wherein masking the one or more data-related entities in the query comprises executing the one or more regular expression operations on the query to:
remove web-connective features;
filter one or more ordinal numbers or one or more hyphen-separated words from a set of hyphen-separated words; or
mask one or more words or phrases in the query that match a pre-defined list of words or phrases by replacing the one or more words or phrases with a pre-determined character string.

6. The non-transitory computer readable medium of claim 1, wherein the operations comprises generating the plurality of quantitative features of the query by:
determining a query length of the query;
determining a referential count indicating a correlation of a set of words in the query to a predetermined set of words; and
generating a readability value for the query based on a number of letters, words, and sentences in the query.

7. The non-transitory computer readable medium of claim 1, wherein generating the label comprises:
generating a text embedding of the query and a normalized numerical feature vector for the plurality of quantitative features of the query; and
generating, based on the text embedding and the normalized numerical feature vector, one or more predictions that the query comprises one or more ambiguities of the plurality of ambiguity types.

8. The non-transitory computer readable medium of claim 1, wherein the operations further comprise generating a plurality of synthetic ambiguous queries by:
removing, from a first set of sample queries, one or more details matching a first predefined pattern of words;
inserting a plurality of referential pronouns into a second set of sample queries; and
replacing, in a third set of sample queries comprising non-question queries, verb-pronoun pairs with one or more phrases from a pre-defined list of phrases marked as ambiguous.

9. The non-transitory computer readable medium of claim 8, wherein the operations further comprise training the small language model by:
generating, utilizing the small language model, predicted labels for the plurality of synthetic ambiguous queries; and
adjusting, utilizing the plurality of synthetic ambiguous queries, parameters of the small language model to reduce differences between the predicted labels and ground-truth labels of the plurality of synthetic ambiguous queries.

10. A system comprising:
one or more memory devices, and
one or more servers configured to cause the system to:
determine a query in a prompt by a client device to a large language model;
generate, utilizing a small language model and a rule-based model, a label indicating that the query comprises an ambiguity of an identified ambiguity type of a plurality of ambiguity types according to a plurality of quantitative features of the query; and
generate, for display to the client device, a response to the query based on the ambiguity of the identified ambiguity type.

11. The system of claim 10, wherein the one or more servers are configured to generate the label by:
generating, utilizing a sentence transformer neural network of the small language model, a text embedding representing the query;
generating, from the query, a feature vector for a plurality of quantitative features of the query; and
generating, utilizing a fully connected neural network of the small language model, the label from the text embedding and the feature vector.

12. The system of claim 11, wherein the one or more servers are configured to cause the system to generate the feature vector by:
determining a query length of the query;
determining a referential count indicating a correlation of a set of words in the query to a predetermined set of words;
generating a readability value for the query based on a number of letters, words and sentences in the query; and
generating the feature vector comprising the query length, the referential count, and the readability value.

13. The system of claim 10, wherein the one or more servers are configured to cause the system to generate the label by:
generating a masked query by masking, utilizing a plurality of regular expression operations, a data-related entity in the query; and
generating, utilizing the rule-based model, the label indicating that the ambiguity is of a lexical ambiguity type in response to determining that an entity type of a set of pre-defined entity types is missing from the masked query.

14. The system of claim 10, wherein the one or more servers are configured to cause the system to generate the label determining, utilizing the small language model, that the identified ambiguity type of the plurality of ambiguity types is a pragmatic ambiguity type or a syntactic ambiguity type.

15. The system of claim 14, wherein the one or more servers are configured to cause the system to generate the label by:
determining, utilizing the small language model, that the query does not include ambiguities of the pragmatic ambiguity type or the syntactic ambiguity type; and
determining, utilizing the rule-based model in response to determining that the query does not include ambiguities of the pragmatic ambiguity type or the syntactic ambiguity type, that the ambiguity is of a lexical ambiguity type.

16. The system of claim 11, wherein the one or more servers are configured to cause the system to generate a plurality of synthetic ambiguous queries for training the small language model by:
removing, from a set of sample queries, one or more details matching a first predefined pattern of words;
inserting a plurality of referential pronouns into the set of sample queries; and
replacing, in non-question queries of the set of sample queries and utilizing a parts-of-speech tagger, verb-pronoun pairs with one or more phrases from a pre-defined list of phrases marked as ambiguous.

17. The system of claim 10, wherein the one or more servers are configured to cause the system to generate the response to the query by:
determining the identified ambiguity type of the ambiguity based on the label indicating that the query comprises the ambiguity; and
generate the response indicating that the query comprises the ambiguity of the identified ambiguity type with a request to clarify the ambiguity.

18. A computer-implemented method comprising:
determining a query in a prompt by a client device to a large language model;
performing a step for generating a label indicating that the query comprises an ambiguity of an identified ambiguity type of a plurality of ambiguity types; and
generating, for display to the client device, a response to the query based on the ambiguity of the identified ambiguity type.

19. The computer-implemented method of claim 18, wherein performing the step for generating the label indicating that the query comprises the ambiguity of the identified ambiguity type comprises determining that the ambiguity is of a syntactic ambiguity type or a pragmatic ambiguity type.

20. The computer-implemented method of claim 18, wherein performing the step for generating the label indicating that the query comprises the ambiguity of the identified ambiguity type comprises determining that the ambiguity of a lexical ambiguity type.
